(19) United States
(12) Patent Application Publication
(10) Pub. No.: US 2011/0157163 A1
(43) Pub. Date: Jun. 30, 2011

(54) IMAGE PROCESSING DEVICE AND IMAGE PROCESSING METHOD

(75) Inventor: Teruhiko Suzuki, Kanagawa (JP)

(73) Assignee: Sony Corporation, Tokyo (JP)

(21) Appl. No.: 12/972,832

(22) Filed: Dec. 20, 2010

(30) Foreign Application Priority Data
Dec. 28, 2009 (JP) 2009-298452

(51) Int. Cl. G06T 15/00

(52) U.S. Cl. 345/419

(57) ABSTRACT

An image processing device includes a reproduction unit configured to reproduce a 3D image data including image data of an image for right eye and an image for left eye set with predetermined parallax, a category specification unit configured to specify a category of the 3D image data to be reproduced by the reproduction unit, a determination unit configured to reference a table in which each category of the 3D image data and a degree of parallax are associated to determine the degree of the parallax corresponding to the category specified by the category specification unit, and a parallax control unit configured to control the parallax of the 3D image data reproduced by the reproduction unit to the degree of the parallax determined by the determination unit.

### BACKGROUND OF THE INVENTION

1. Field of the Invention The present invention relates to an image processing device and an image processing method, and particularly relates to an image processing device and an image processing method by which a viewer can further enjoy a 3D image data. 2. Description of the Related Art

A 3D (three-dimensional) display system is an image display system which has become possible in recent years along with an increase in the number of pixels and an increase in frame rate of a display such as a liquid crystal display (LCD). With the 3D display system, a viewer can recognize an object three-dimensionally. Hereinafter, an image in which an object can be recognized three-dimensionally by viewing is referred to as a 3D image and a content including data of the 3D image is referred to as a 3D image data, as appropriate.

Methods of viewing the 3D image include a method with glasses using polarization filter glasses or shutter glasses and a method with the naked eye without the use of glasses such as a lenticular method. As a reproducing method for displaying the 3D image, there is a frame sequential method in which an image for left eye and an image for right eye with parallax are displayed alternately. By showing the image for left eye and the image for right eye respectively to the left and right eyes of the viewer with shutter glasses or the like, it is possible to create a three-dimensional feel for the viewer.

For example, Japanese Unexamined Patent Application Publication No. 2006-262191 discloses a display device with which using one three-dimensional image display device enables multiple observers to view a 3D image individually in a display manner suitable for each one.

### SUMMARY OF THE INVENTION

A 3D image data in categories such as, for example, action and sports is commonly more enjoyable when the 3D image data provides a stronger three-dimensional feel, and it has been desired that a 3D image data be more enjoyable for a viewer.

It is desirable to enable a viewer to further enjoy a 3D image data.

An image processing device according to an embodiment of the present invention includes reproduction means configured to reproduce a 3D image data including image data of an image for right eye and an image for left eye set with predetermined parallax, category specification means configured to specify a category of the 3D image data to be reproduced by the reproduction means, determination means configured to reference a table in which each category of the 3D image data and a degree of parallax are associated to determine the degree of the parallax corresponding to the category specified by the category specification means, and parallax control means configured to control the parallax of the 3D image data reproduced by the reproduction means to the degree of the parallax determined by the determination means.

An image processing method according to another embodiment of the present invention includes the steps of reproducing a 3D image data including image data of an image for right eye and an image for left eye set with predetermined parallax, specifying a category of the 3D image data to be reproduced, referencing a table in which each category of the 3D image data and a degree of parallax are associated to determine the degree of the parallax corresponding to the specified category, and controlling the parallax of the reproduced 3D image data to the determined degree of the parallax.

According to still another embodiment of the present invention, a 3D image data including image data of an image for right eye and an image for left eye set with predetermined parallax is reproduced, a category of the 3D image data to be reproduced is specified, a table in which each category of the 3D image data and a degree of parallax are associated is referenced to determine the degree of the parallax corresponding to the specified category, and the parallax of the reproduced 3D image data is controlled to the determined degree of the parallax.

According to the embodiments of the present invention, a viewer can further enjoy a 3D image data.

### BRIEF DESCRIPTION OF THE DRAWINGS

FIG. 1 illustrates a configuration example of a 3D image display system according to an embodiment of the present invention;

FIG. 2 is a block diagram showing a configuration example of a display control device;

FIG. 3 is a block diagram showing a configuration example of a reproduction processing unit;

FIG. 4 illustrates a 3D image data category table;

FIG. 5 illustrates a parallax control table;

FIG. 6 is a flowchart illustrating processing by the reproduction processing unit; and

FIG. 7 is a block diagram showing a configuration example of a computer according to an embodiment of the present invention.

### DESCRIPTION OF THE PREFERRED EMBODIMENTS

A specific embodiment of the present invention will be described below in detail with reference to the accompanying drawings.

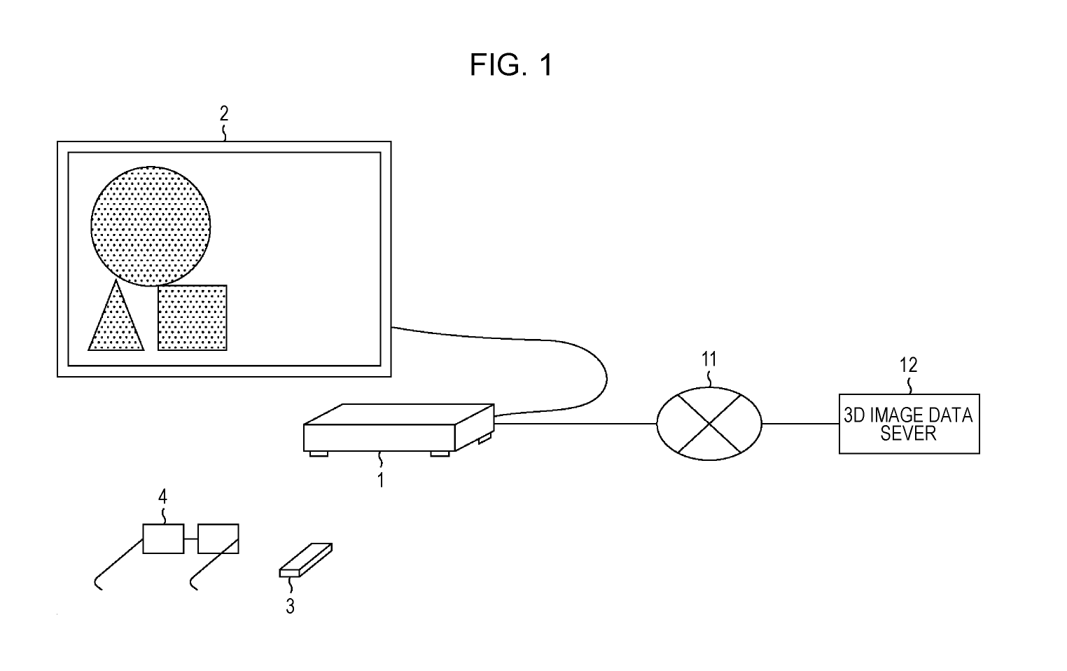

FIG. 1 illustrates a configuration example of a 3D image display system according to an embodiment of the present invention. Note that, in this specification, a system refers to an entire apparatus configured of multiple devices.

The 3D image display system in FIG. 1 includes a display control device 1, a television receiver (TV) 2, a remote commander 3, and shutter glasses 4 to be worn by a user who is a viewer of image data. That is, a method of viewing a 3D image with the 3D image display system in FIG. 1 is a method using glasses. The display control device 1 and the TV 2 are connected by, for example, a High-Definition Multimedia Interface (HDMI) cable.

The display control device 1 is connected with a 3D image data sever 12 via a network 11 including the Internet or the like. Communication between the display control device 1 and the 3D image data sever 12 is performed via the network 11, and a 3D image data stored in the 3D image data sever 12 is sent to the display control device 1. The 3D image data sever 12 is a server that provides the 3D image data in response to a request from an appliance which has made access via the network 11.

The display control device 1 is installed with a Web browser. For example, based on data such as an HTML file sent from the 3D image data sever 12 when the 3D image data sever 12 has been accessed, the display control device 1 causes the TV 2 to display a selection screen displaying aligned thumbnail images representing viewable 3D image data. The user can give an instruction to start receiving and reproducing the 3D image data by operating and moving a cursor displayed on the screen and designating the thumbnail image through operation of the remote commander 3.

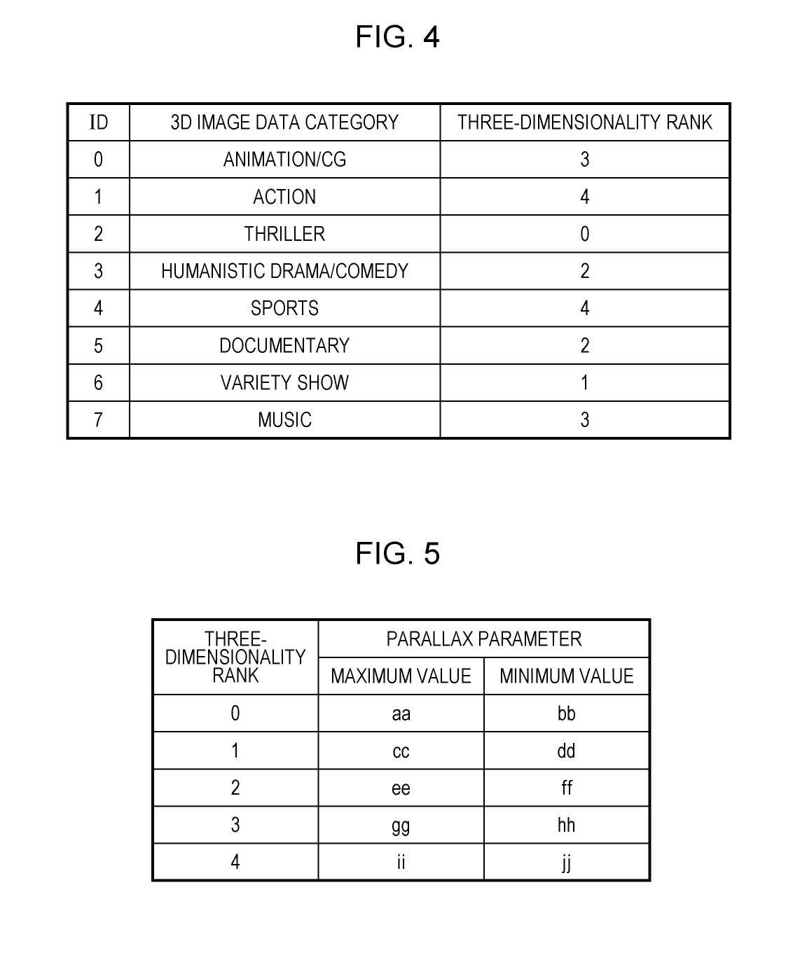

The 3D image data provided by the 3D image data sever 12 includes image data of an image for right eye, image data of an image for left eye, and additional data. The additional data includes, for example, category information (see FIG. 4) showing a category of the 3D image data. Note that the 3D image data also includes sound data reproduced in accordance with the reproduction of the image data.

The display control device 1 reproduces the 3D image data sent from the 3D image data sever 12 and causes the TV 2 to alternately display the image for right eye and the image for left eye. At this time, the display control device 1 performs a parallax control to adjust the degree of parallax according to the category of the 3D image data.

The shutter glasses 4 is supplied from the display control device 1 with a control signal including information of a vertical synchronization signal of the image through, for example, wireless communication using infrared light. A transparent portion on the left eye side and a transparent portion on the right eye side of the shutter glasses 4 are configured of liquid crystal devices capable of controlling the polarization characteristics thereof. According to the control signal, the shutter glasses 4 alternately repeat two operations of opening and closing shutters, i.e., opening the left eye while closing the right eye and closing the left eye while opening the right eye. As a result, the image for right eye and the image for left eye are respectively input only to the right eye and the left eye of the user. By seeing the image for right eye and the image for left eye alternately, the user senses an object to be three-dimensional.

In this manner, the display control device 1 performs the reproduction of the 3D image data sent from the 3D image data sever 12.

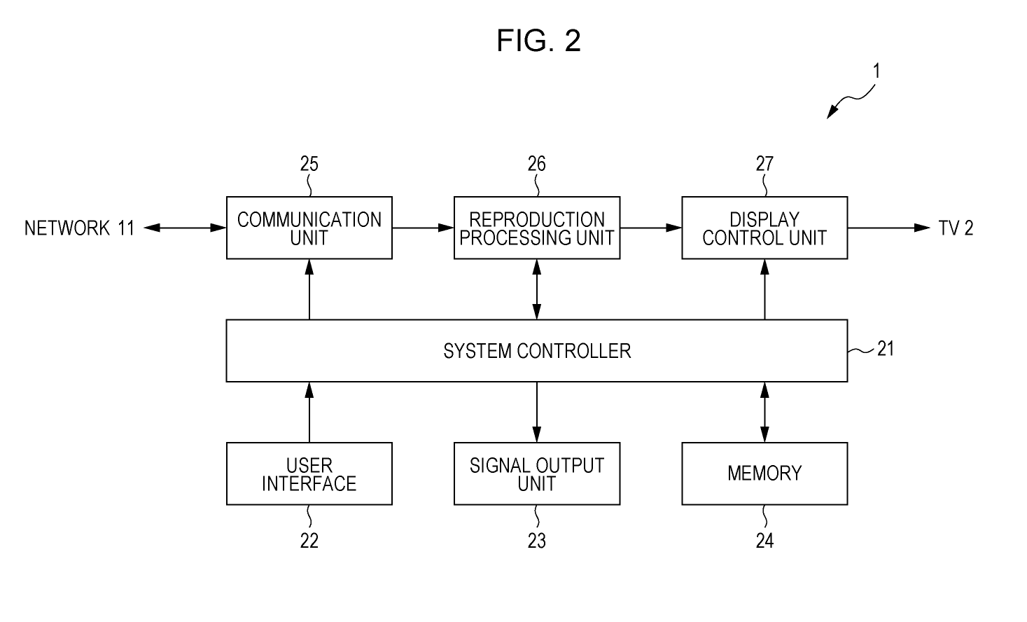

Next, FIG. 2 is a block diagram showing a configuration example of the display control device 1.

As shown in FIG. 2, the display control device 1 includes a system controller 21, a user interface 22, a signal output unit 23, a memory 24, a communication unit 25, a reproduction processing unit 26, and a display control unit 27.

The system controller 21 includes a central processing unit (CPU), read only memory (ROM), a random access memory (RAM), or the like and controls the entire operation of the display control device 1 according to a signal, representing content of an operation by the user, supplied from the user interface 22. For example, the system controller 21 receives the 3D image data delivered from the 3D image data sever 12 by controlling the communication unit 25 and reproduces the 3D image data by controlling the reproduction processing unit 26.

The user interface 22 detects the operation by the user with respect to the remote commander 3 and outputs the signal representing the content of the operation to the system controller 21.

The signal output unit 23 sends the control signal supplied from the system controller 21 to the shutter glasses 4. In the shutter glasses 4 which have received the control signal sent from the signal output unit 23, shutter operations in the transparent portion on the left eye side and the transparent portion on the right eye side are controlled.

The memory 24 is a rewritable memory such as a flash memory (for example, electronically erasable and programmable read only memory (EEPROM)) and stores personal information of the user, various setting information, or the like registered in the display control device 1.

The communication unit 25 is an interface for the network 11 and performs communication with the 3D image data sever 12 via the network 11. The communication unit 25 makes a request to send a predetermined 3D image data with respect to the 3D image data sever 12 according to a control by the system controller 21, receives the sent 3D image data, and outputs the 3D image data to the reproduction processing unit 26.

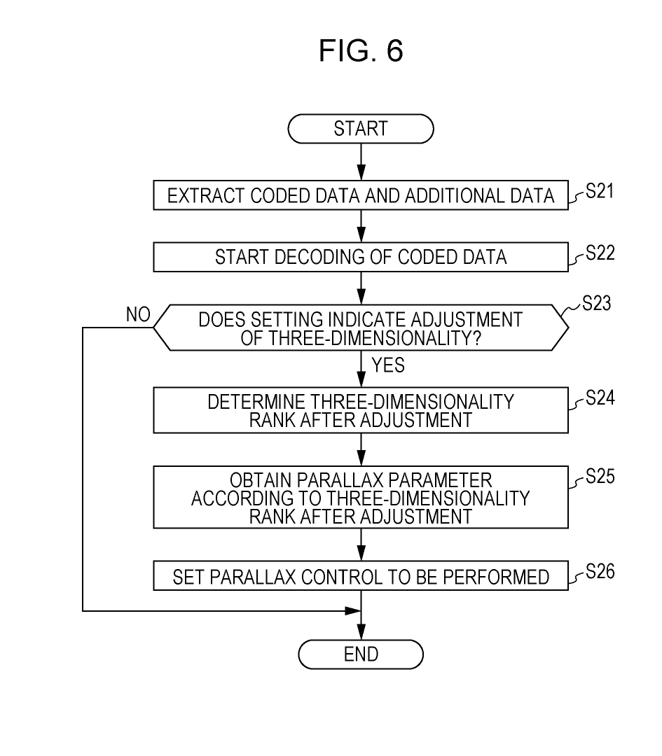

The reproduction processing unit 26 performs a reproduction process, such as a decode process of decompressing compressed data, with respect to the 3D image data to be reproduced which is supplied from the communication unit 25. The reproduction processing unit 26 outputs the image data of the image for right eye and the image for left eye obtained through reproduction of the 3D image data to the display control unit 27. Also, the reproduction processing unit 26 performs the parallax control suitable for the category of the 3D image data, as will be described later with reference to a flowchart in FIG. 6. Note that the sound data used for outputting sound in accordance with the image of the image data is output to an external speaker or the like via a circuit (not shown) from the reproduction processing unit 26.

The display control unit 27 controls display of the TV 2 based on the image data of the image for right eye and the image for left eye supplied from the reproduction processing unit 26 and causes the TV 2 to alternately display the image for right eye and the image for left eye.

In the display control device 1 configured in this manner, the 3D image data delivered from the 3D image data sever 12 is received by the communication unit 25 and the reproduction process is performed by the reproduction processing unit 26. The 3D image data includes, as described above, the image data of the image for right eye, the image data of the image for left eye, and the additional data, and multiplexed data into which these pieces of data are multiplexed is delivered from the 3D image data sever 12. Note that the category information or the like as the additional data can be, for example, stored as user data for video, defined in a descriptor of an MPEG-2 transport stream (TS), or defined in an MPEG-4 box.

In the reproduction processing unit 26 of the display control device 1, the category information included in the additional data extracted from the 3D image data to be reproduced is referenced and the parallax control suitable for the category of the 3D image data is performed, so that the 3D image data of which the three-dimensionality is adjusted (reduced) is displayed in the TV 2.

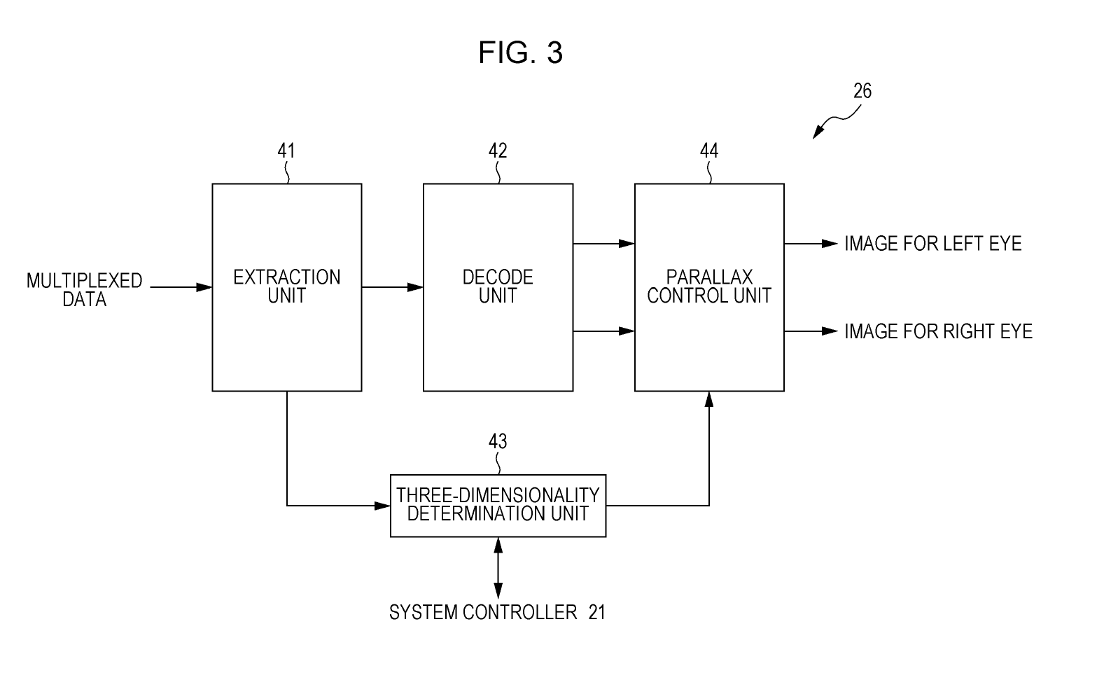

Next, FIG. 3 is a block diagram showing a configuration example of the reproduction processing unit 26 in FIG. 2.

As shown in FIG. 3, the reproduction processing unit 26 includes an extraction unit 41, a decode unit 42, a three-dimensionality determination unit 43, and a parallax control unit 44.

The multiplexed data of the 3D image data received from the communication unit 25 in FIG. 2 is supplied to the extraction unit 41, and the extraction unit 41 divides the multiplexed data to extract coded data and the additional data. Then, the extraction unit 41 supplies the coded data to the decode unit 42 and supplies the additional data to the three-dimensionality determination unit 43.

The decode unit 42 supplies the image data obtained by decoding the coded data from the extraction unit 41 to the parallax control unit 44. That is, the decode unit 42 decodes the coded data of the image for right eye to supply the image data of the image for right eye obtained as a result to the parallax control unit 44, and also decodes the coded data of the image for left eye to supply the image data of the image for left eye obtained as a result to the parallax control unit 44.

The three-dimensionality determination unit 43 references information stored in the memory 24 via the system controller 21 based on the additional data from the extraction unit 41 and judges whether to adjust the three-dimensionality in reproducing the delivered 3D image data. The memory 24 stores the setting information showing various settings registered by the user with respect to the display control device 1. The setting information includes, for example, information (flag) showing whether the adjustment of the three-dimensionality is to be performed. For example, the user can set the display control device 1 to perform the adjustment of the three-dimensionality through operation of the remote commander 3.

When the three-dimensionality of the 3D image data is to be adjusted, the three-dimensionality determination unit 43 determines the three-dimensionality after adjustment and supplies the parallax control unit 44 with a maximum value and a minimum value of a parallax parameter showing a range of the parallax parameter for such three-dimensionality. Herein, a value of the parallax parameter and a difference in parallax are in proportion to each other; a greater value of the parallax parameter indicates a greater difference in parallax between the image for right eye and the image for left eye, whereby the user seeing the 3D image data feels the object to be more three-dimensional and sees the object as standing out further. That is, the parallax parameter shows a stand-out amount which is the degree of the object of the 3D image data seen by the user standing out. Specifically, an example of the parallax parameter is the magnitude of a vector directed from a predetermined point of the object shown in the image for right eye toward a point of the object in the image for left eye corresponding to the predetermined point when the image for right eye and the image for left eye are superimposed.

The three-dimensionality determination unit 43 stores a 3D image data category table in which the category of the 3D image data and a three-dimensionality rank set as suitable for each category are associated and registered and a parallax control table in which the maximum value and the minimum value of the parallax parameter according to the three-dimensionality rank are registered. Based on the category information included in the additional data from the extraction unit 41, the 3D image data category table, and the parallax control table, the three-dimensionality determination unit 43 determines the three-dimensionality of the 3D image data after adjustment and obtains the maximum value and the minimum value of the parallax parameter.

As shown in FIG. 4, the 3D image data category table is a table in which the category of the 3D image data and the three-dimensionality rank suitable for each category of the 3D image data are associated and registered. In the 3D image data category table, category “animation/CG” is associated with a three-dimensionality rank “3” for an entry of ID 0, and category “action” is associated with a three-dimensionality rank “4” for an entry of ID 1. Also, category “thriller” is associated with a three-dimensionality rank “0” for an entry of ID 2, and category “humanistic drama/comedy” is associated with a three-dimensionality rank “2” for an entry of ID 3. Also, category “sports” is associated with a three-dimensionality rank “4” for an entry of ID 4, and category “documentary” is associated with a three-dimensionality rank “2” for an entry of ID 5. Also, category “variety show” is associated with a three-dimensionality rank “1” for an entry of ID 6, and category “music” is associated with a three-dimensionality rank “3” for an entry of ID 7.

As shown in FIG. 5, the parallax control table is a table in which the three-dimensionality rank and the maximum value as well as the minimum value of the parallax parameter are associated and registered. In the parallax control table, the three-dimensionality rank “0” is associated with a maximum value “aa” as well as a minimum value “bb” of the parallax parameter, and the three-dimensionality rank “1” is associated with a maximum value “cc” as well as a minimum value “dd” of the parallax parameter. Also, the three-dimensionality rank “2” is associated with a maximum value “ee” as well as a minimum value “ff” of the parallax parameter, the three-dimensionality rank “3” is associated with a maximum value “gg” as well as a minimum value “hh” of the parallax parameter, and the three-dimensionality rank “4” is associated with a maximum value “ii” as well as a minimum value “jj” of the parallax parameter.

When the maximum value and the minimum value of the parallax parameter are supplied from the three-dimensionality determination unit 43, the parallax control unit 44 performs the parallax control with respect to the image data of the image for right eye and the image for left eye supplied from the decode unit 42 according to the range of the parallax parameter to adjust the three-dimensionality of the 3D image data. When the parallax between the image for right eye and the image for left eye is greater than or equal to the maximum value of the parallax parameter, the parallax control unit 44 causes, for example, as an offset in the image for left eye, the position of the object in the image for left eye to be closer to the object shown in the image for right eye when the image for right eye and the image for left eye are superimposed to perform a control of bringing the parallax within the range of the parallax parameter from the three-dimensionality determination unit 43. The image data of the image for right eye and the image for left eye of the 3D image data of which the parallax is adjusted in this manner is output from the parallax control unit 44.

In this manner, in the reproduction processing unit 26, the three-dimensionality of the 3D image data to be reproduced is determined by the three-dimensionality determination unit 43 and the 3D image data adjusted by the parallax control unit 44 to have the determined three-dimensionality or less is output.

Next, FIG. 6 is the flowchart illustrating a process of performing the parallax control with the reproduction processing unit 26 in FIG. 3.

For example, the process starts when the multiplexed data of the 3D image data delivered from the 3D image data sever 12 is supplied to the reproduction processing unit 26, and, in step S21, the extraction unit 41 extracts the coded data and the additional data from the multiplexed data. When the extraction unit 41 supplies the coded data to the decode unit 42 and supplies the additional data to the three-dimensionality determination unit 43, the process proceeds to step S22.

In step S22, the decode unit 42 starts decoding of the coded data supplied from the extraction unit 41 and sequentially supplies the parallax control unit 44 with the image data of the image for right eye and the image for left eye obtained as a result of the decoding.

In step S23, the three-dimensionality determination unit 43 references the setting information (information showing whether to perform the adjustment of the three-dimensionality) stored in the memory 24 via the system controller 21 and determines whether the setting indicates adjustment of the three-dimensionality.

When it is determined that the setting indicates adjustment of the three-dimensionality by the three-dimensionality determination unit 43 in step S23, the process proceeds to step S24. In step S24, the category of the 3D image data is specified based on the category information included in the additional data supplied from the extraction unit 41 in step S21. Then, the three-dimensionality determination unit 43 references the 3D image data category table (see FIG. 4) and determines the three-dimensionality rank associated with the specified category as the three-dimensionality to be applied to the 3D image data after adjustment of the three-dimensionality.

After a process of step S24, the process proceeds to step S25 where the three-dimensionality determination unit 43 references the parallax control table (see FIG. 5) to obtain and supply the parallax control unit 44 with the maximum value and the minimum value of the parallax parameter associated with the three-dimensionality rank determined in step S24.

After a process of step S25, the process proceeds to step S26 where the parallax control unit 44 sets the parallax control to be performed such that a parallax degree of the 3D image data based on the image data of the image for right eye and the image for left eye supplied from the decode unit 42 falls within the range between the maximum value and the minimum value of the parallax parameter supplied from the three-dimensionality determination unit 43 and starts the parallax control according to such setting.

After a process of step S26, or when it is determined that the setting does not indicate adjustment of the three-dimensionality by the three-dimensionality determination unit 43 in step S23, the process is terminated.

Since the reproduction processing unit 26 adjusts the three-dimensionality of the 3D image data according to the category of the 3D image data in a manner described above, the three-dimensionality can be increased for a 3D image data of, for example, action or sports which is more enjoyable with a higher three-dimensionality. Thus, a sense of immersion of the viewer with respect to the 3D image data can be strengthened, and the viewer can further enjoy the 3D image data.

Note that the category information of the 3D image data is not limited to that delivered as the additional data of the 3D image data and may also be, for example, acquired from an electronic program guide (EPG). That is, even if the category information is not added to the 3D image data, the parallax control according to the category can be performed. Also, the display control device 1 may analyze the category of the 3D image data to perform the parallax control, or the user may input the category through operation of the remote commander 3.

Note that, for example, the reproduction processing unit 26 may perform the parallax control in a predetermined section of the 3D image data besides performing the parallax control identical throughout the entire 3D image data. For example, the reproduction processing unit 26 can detect whether there are consecutive sections with large parallax in the 3D image data and, when there are consecutive sections with large parallax, apply a lower three-dimensionality to the 3D image data being reproduced. For example, since a sense of fatigue generally increases when the 3D image data with large parallax is viewed continually for a long period of time, the sense of fatigue of the viewer can be reduced by reducing the parallax when there are consecutive sections with large parallax even if the three-dimensionality of the image data is high.

Also, the display control device 1 can analyze the 3D image data to detect a timing (scene change) at which a scene changes in the 3D image data and perform the parallax control to reduce the parallax between before and after the scene change. Accordingly, for example, the sense of fatigue occurring in the viewer due to change in the parallax between before and after the scene change can be reduced.

Note that although the example in which the 3D image data is delivered from the 3D image data sever 12 via the network 11 has been described in this embodiment, the 3D image data may be, for example, provided through recording on a disk or provided through broadcasting utilizing broadcast waves. In such cases, the display control device 1 can acquire the 3D image data with a disk drive or acquire the 3D image data via a receiver device that receives broadcast waves.

The embodiment of the present invention can be applied to, for example, an image processing device which performs a process with respect to a 3D image data including a multiview image formed of three or more images besides an image processing device which performs a process with respect to a 3D image data including two images (so-called stereo image), i.e., an image for right eye and an image for left eye. That is, a process similar to the process described above can be applied to a control of parallax with respect to two images, within the multiview image including the multiple images, which cause an object to appear three-dimensionally from a direction of a user.

A sequence of the processes (image processing method) described above can be executed with hardware or can be executed with software. When the sequence of the processes is to be executed with software, a program forming the software is installed from a program recording medium, in which the program is recorded, on a computer built in dedicated hardware or, for example, a general personal computer capable of executing various functions by installing various programs.

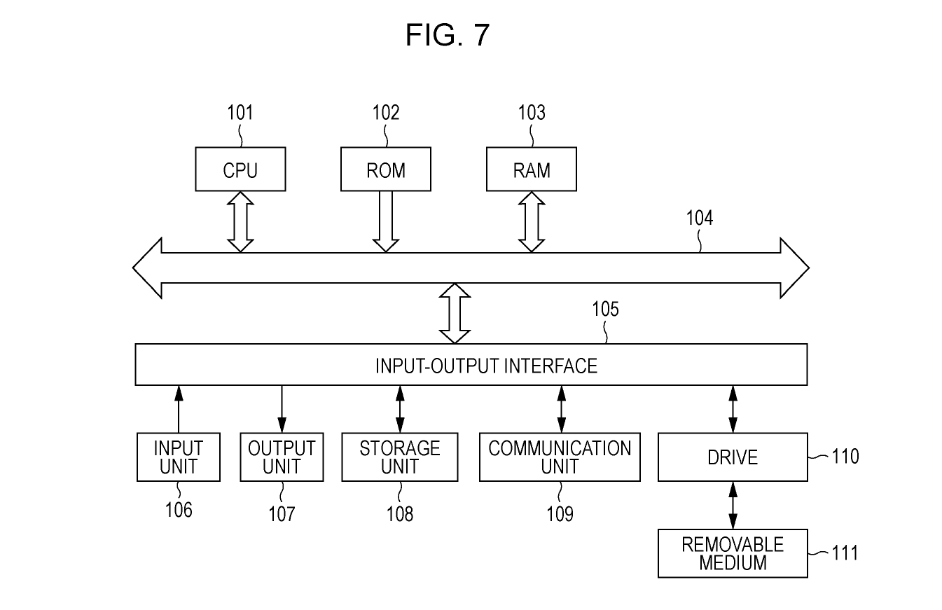

FIG. 7 is a block diagram showing a configuration example of hardware of a computer which executes the sequence of processes described above through a program.

In the computer, a central processing unit (CPU) 101, a read only memory (ROM) 102, a random access memory (RAM) 103, and a bus 104 are interconnected.

The bus 104 is further connected with an input-output interface 105. The input-output interface 105 is connected with an input unit 106 including a keyboard, a mouse, and a microphone, an output unit 107 including a display and a speaker, a storage unit 108 including a hard disk or a nonvolatile memory, a communication unit 109 including a network interface, and a drive 110 which drives a removable medium 111 such as a magnetic disk, an optical disc, a magneto-optical disk, or a semiconductor memory. In the computer configured in a manner described above, the sequence of processes described above is performed by, for example, the program stored in the storage unit 108 being loaded and executed in the RAM 103 by the CPU 101 via the input-output interface 105 and the bus 104.

The program to be executed by the computer (the CPU 101) is, for example, provided through recording in the removable medium 111 which is a media package including a magnetic disk (including a flexible disk), an optical disc (such as a compact disc-read only memory (CD-ROM) or a digital versatile disc (DVD)), a magneto-optical disk, or a semiconductor memory or via a wired or wireless transmission medium such as a local area network, the Internet, or digital satellite broadcasting.

The program can be installed in the storage unit 108 via the input-output interface 105 by connecting the removable medium 111 to the drive 110. Also, the program can be received by the communication unit 109 via the wired or wireless transmission medium and installed in the storage unit 108. Otherwise, the program can be installed in advance in the ROM 102 or the storage unit 108.

Note that the program executed by the computer may be a program which performs the processes in the chronological order described in this specification or may be a program which performs the processes in parallel or at appropriate timings such as upon a call.

The present application contains subject matter related to that disclosed in Japanese Priority Patent Application JP 2009-298452 filed in the Japan Patent Office on Dec. 28, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing device comprising:
reproduction means configured to reproduce a 3D image data including image data of an image for right eye and an image for left eye set with predetermined parallax;
category specification means configured to specify a category of the 3D image data to be reproduced by the reproduction means;
determination means configured to reference a table in which each category of the 3D image data and a degree of parallax are associated to determine the degree of the parallax corresponding to the category specified by the category specification means; and
parallax control means configured to control the parallax of the 3D image data reproduced by the reproduction means to the degree of the parallax determined by the determination means.

2. The image processing device according to claim 1, wherein:
the determination means references a parallax control table in which the degree of the parallax and a parallax parameter showing a difference in the parallax controlled by the parallax control means are associated to obtain the parallax parameter corresponding to the degree of the parallax determined according to the category; and
the parallax control means controls the parallax of the 3D image data according to the parallax parameter obtained by the determination means.

3. The image processing device according to claim 2, wherein:
the parallax control table associates the degree of the parallax with a maximum value and a minimum value of the parallax parameter; and
the parallax control means controls the parallax of the 3D image data to fall within a range between the maximum value and the minimum value of the parallax parameter obtained by the determination means.

4. An image processing method comprising the steps of:
reproducing a 3D image data including image data of an image for right eye and an image for left eye set with predetermined parallax;
specifying a category of the 3D image data to be reproduced;
referencing a table in which each category of the 3D image data and a degree of parallax are associated to determine the degree of the parallax corresponding to the specified category; and
controlling the parallax of the reproduced 3D image data to the determined degree of the parallax.

5. An image processing device comprising:
a reproduction unit configured to reproduce a 3D image data including image data of an image for right eye and an image for left eye set with predetermined parallax;
a category specification unit configured to specify a category of the 3D image data to be reproduced by the reproduction unit;
a determination unit configured to reference a table in which each category of the 3D image data and a degree of parallax are associated to determine the degree of the parallax corresponding to the category specified by the category specification unit; and
a parallax control unit configured to control the parallax of the 3D image data reproduced by the reproduction unit to the degree of the parallax determined by the determination unit.
